(19) United States
(12) Patent Application Publication
(10) Pub. No.: US 2015/0330430 A1
(43) Pub. Date: Nov. 19, 2015

(54) CONNECTOR

(71) Applicant: Ross G. Krieger, Boone, IA (US)

(72) Inventor: Ross G. Krieger, Boone, IA (US)

(21) Appl. No.: 14/279,711

(22) Filed: May 16, 2014

(51) Int. Cl. F16B 12/10; F16B 12/50

(52) U.S. Cl. CPC F16B 12/10; F16B 12/50

(57) ABSTRACT

Example embodiments disclose a connector that includes a body, a securing member extending from a first side of the body, and a protruding member extending from a second side of the body. In example embodiments, the connector may be used in a system to attach various structures to one another.

### BACKGROUND

1. Field

Example embodiments relate to a connector configured to attach to a structure. Example embodiments also relate to systems that include the connector and methods for attaching structures together.

2. Description of the Related Art

Wooden pallets are used as platforms upon which various sorts of items are placed. The pallets are easily moved by forklifts and thus have great utility. However, the pallets generally do not have a practical purpose outside of the above purpose. Some artisans have sought to recycle used pallets and have thus designed pallet systems. These systems, however, generally include complicated fittings, are often difficult to use, and are often expensive.

### SUMMARY

Example embodiments relate to a connector configured to attach to a structure. Example embodiments also relate to systems that include the connector and methods for attaching structures together.

In accordance with example embodiments, a connector may include a body, a securing member extending from a first side of the body, and a protruding member extending from a second side of the body. In example embodiments, the connector may be used in a system to attach various structures to one another. In example embodiments, the structures may be, but are not required to be, wooden pallets.

### BRIEF DESCRIPTION OF THE DRAWINGS

Example embodiments are described in detail below with reference to the attached drawing figures, wherein:

FIG. 1 is a perspective view of a connector in accordance with example embodiments;

FIG. 2 a perspective view of the connector in accordance with example embodiments;

FIG. 3 is a side view of the connector in accordance with example embodiments;

FIG. 4 is a top view of the connector in accordance with example embodiments;

FIG. 5 is a bottom view of the connector in accordance with example embodiments;

FIG. 6 is a view of a structure in accordance with example embodiments;

FIG. 7A is an exploded view of a first system in accordance with example embodiments;

FIG. 7B is a perspective view of the first system in accordance with example embodiments;

FIG. 8 is a view of a column in accordance with example embodiments;

FIG. 9A is an exploded view of a second system in accordance with example embodiments;

FIG. 9B is a partial exploded view of the second system in accordance with example embodiments;

FIG. 9C is a view of the second system in accordance with example embodiments;

FIG. 10A is an exploded view of a third system in accordance with example embodiments;

FIG. 10B is a view of the third system in accordance with example embodiments;

FIG. 11 is a view of a connector in accordance with example embodiments;

FIG. 12 is a view of a connector in accordance with example embodiments;

FIG. 13 is a view of a connector in accordance with example embodiments;

FIG. 14 is a view of a column in accordance with example embodiments; and

FIGS. 15A-15B are views of a connector in accordance with example embodiments.

### DETAILED DESCRIPTION

Example embodiments will now be described more fully with reference to the accompanying drawings, in which example embodiments of the invention are shown. The invention may, however, be embodied in different forms and should not be construed as limited to the example embodiments set forth herein. Rather, these example embodiments are provided so that this disclosure will be thorough and complete, and will fully convey the scope of the invention to those skilled in the art. In the drawings, the sizes of components may be exaggerated for clarity.

In this application, it is understood that when an element or layer is referred to as being “on,” “attached to,” “connected to,” or “coupled to” another element or layer, it can be directly on, directly attached to, directly connected to, or directly coupled to the other element or layer or intervening elements that may be present. In contrast, when an element is referred to as being “directly on,” “directly attached to,” “directly connected to,” or “directly coupled to” another element, there are no intervening elements present. As used herein, the term “and/or” includes any and all combinations of one or more of the associated listed items.

In this application it is understood that, although the terms first, second, etc. may be used herein to describe various elements and/or components, these elements and/or components should not be limited by these terms. These terms are only used to distinguish one element, component, region, layer, and/or section from another elements, component, region, layer, and/or section. Thus, a first element, component region, layer or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures. For example, if the structure in the figures is turned over, elements described as “below” or “beneath” other elements or features would then be oriented “above” the other elements or features. Thus, the exemplary term “below” can encompass both an orientation of above and below. The structure may be otherwise oriented (rotated 90 degrees or at other orientations) and the spatially relative descriptors used herein interpreted accordingly.

Embodiments described herein will refer to planform views and/or cross-sectional views by way of ideal schematic views. Accordingly, the views may be modified depending on manufacturing technologies and/or tolerances. Therefore, example embodiments are not limited to those shown in the views, but include modifications in configurations formed on the basis of manufacturing process. Therefore, regions exemplified in the figures have schematic properties and shapes of regions shown in the figures exemplify specific shapes or regions of elements, and do not limit example embodiments.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to connector configured to attach to a structure, systems including the connector, and methods of attaching structures together.

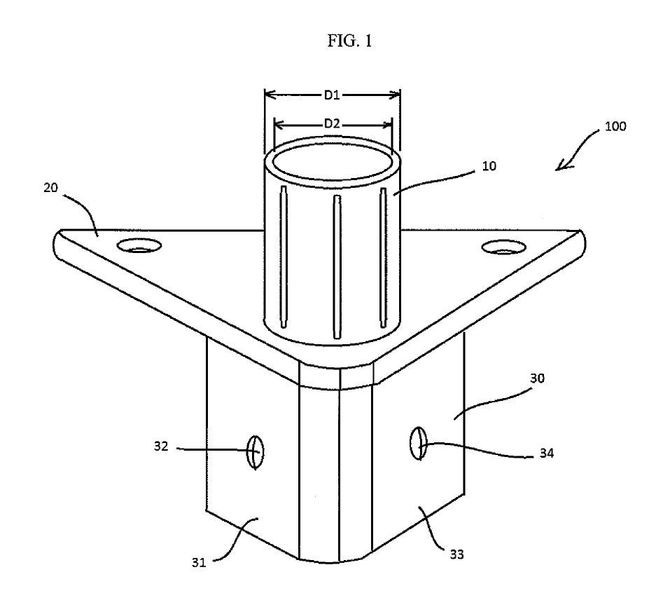

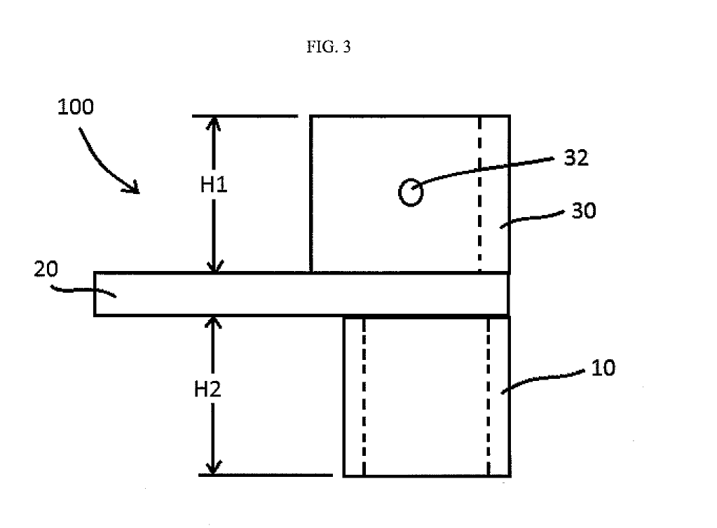

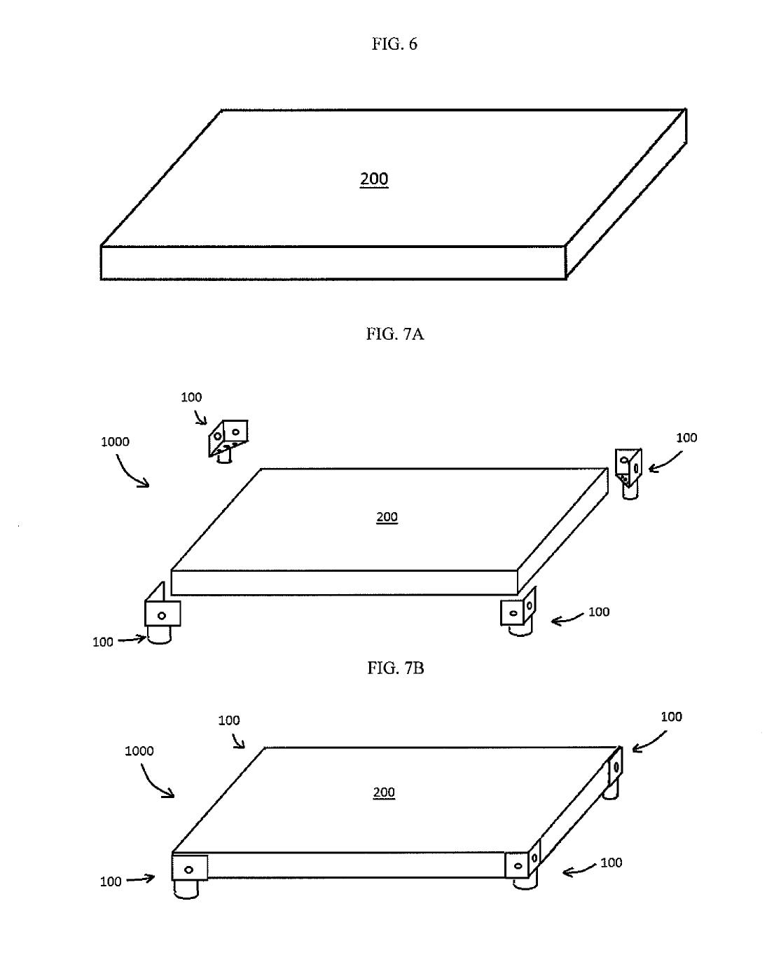

FIGS. 1-5 are views of a connector 100 in accordance with example embodiments. As shown in FIGS. 1-5, the connector 100 may include a body 20, a securing member 30 extending from a first side of the body 20, and a protruding member 10 extending from a second side of the body 20. In example embodiments, the connector 100 may be configured to connect to a structure, for example, a flat wooden pallet.

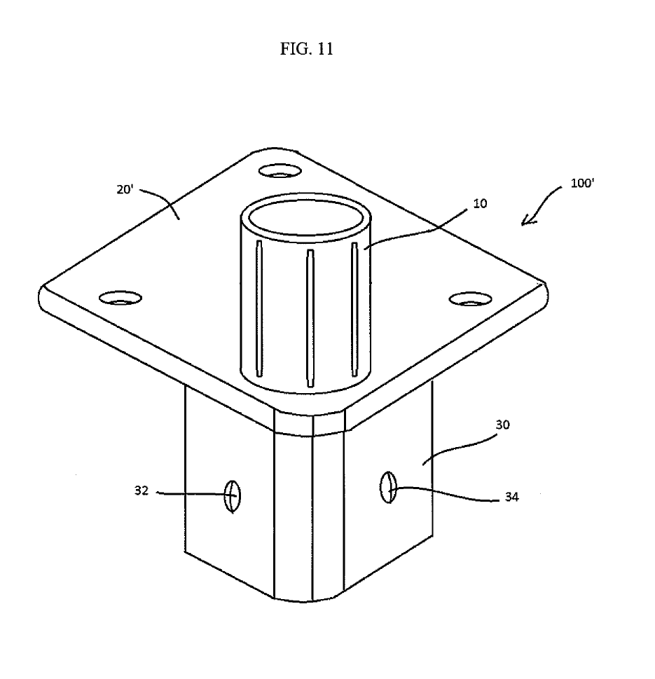

In example embodiments the body 20 of the connector 100 may resemble a flat plate. For example, in example embodiments, a thickness of the body 20 may be substantially constant as shown in the figures. This, however, is not meant to limit the invention as the body 20 may have a variable thickness or even a stepped thickness. In example embodiments the body 20 is illustrated as resembling a triangular shaped plate. This, again, is not meant to limit example embodiments. For example, rather than being triangular shaped, the body 20 may be in the shape of a rectangle when viewed from above and/or below (see FIG. 11). As another nonlimiting example, the body 20 may include an arcuate profile. For example, the body 20 may resemble a quarter circle when viewed from above or below. In short, while the body 20 is illustrated as having a triangular shape, the shape of the body 20 is not meant to limit the invention.

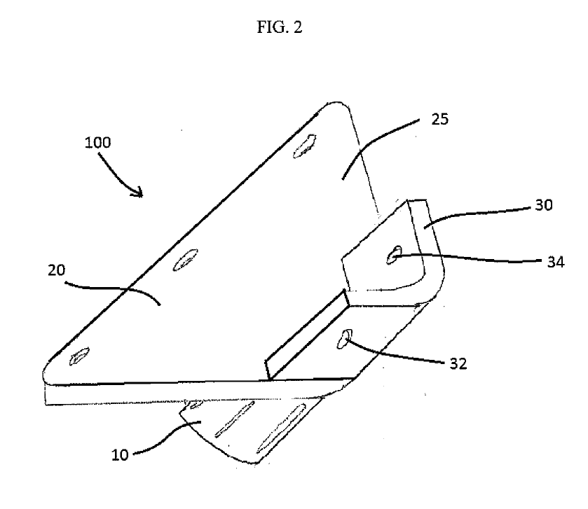

In example embodiments the body 20 may include at least one hole extending through a thickness thereof. For example, as shown in at least FIGS. 2, 4, and 5, the body 20 may have a first hole 22, a second hole 24, and a third hole 26 extending therethrough. The number of holes, however, is not meant to limit the invention. For example, the body 20, rather than having three holes, may have a single hole, two holes, or more than three holes extending therethrough.

In example embodiments, the holes in the body 20 may accommodate a fastener to connect the body 20 to a structure. For example, in example embodiments, the fastener may be, but is not required to be, a nail or a screw which has a body that passes through the holes of the body 20 to connect the body to the structure. Thus, the holes in the body 20 may facilitate connecting the connector 100 to a structure such as a wooden pallet. This, however, is not meant to be a limiting feature of example embodiments. For example, rather than using fasteners, like nails or screws, to attach the connector 100 to the structure, an adhesive may be applied to a surface 25 (see FIG. 2) of the body 20 to connect the body 20 to the structure. As such, the connector 100 is not required to include holes passing therethrough since the body 20 may be connected to the structure by an adhesive.

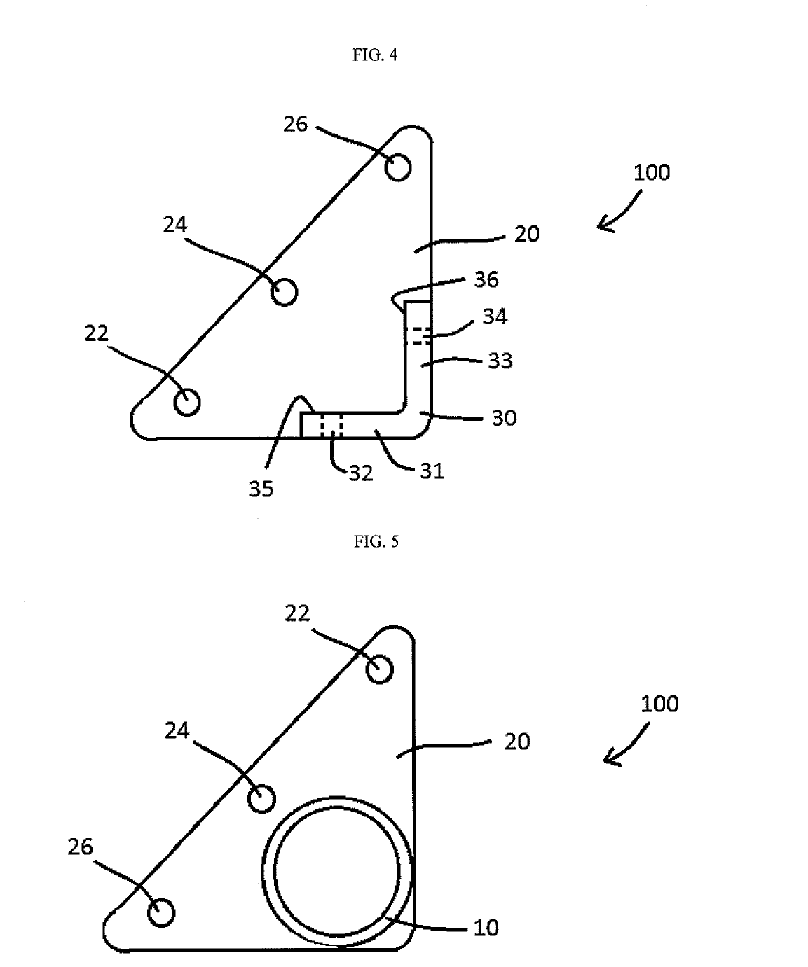

In example embodiments, the securing member 30 may extend from a first side of the body 20 as shown in the figures. Though not required, the securing member 30 may be substantially perpendicular to the body 20. In example embodiments, the securing member 30 may resemble an L-shaped member having a first wing 31 and a second wing 33 (see FIG. 4). The shape of the securing member 30, however, is not meant to limit the invention. For example, in example embodiments, the securing member 30 may have another shape such as, but not limited to, a C-shape or a J-shape. In the alternative, the securing member 30 may resemble a couple of bars extending from the first side of the body 20. Thus, the particular shape of the securing member 30 is not meant to limit example embodiments.

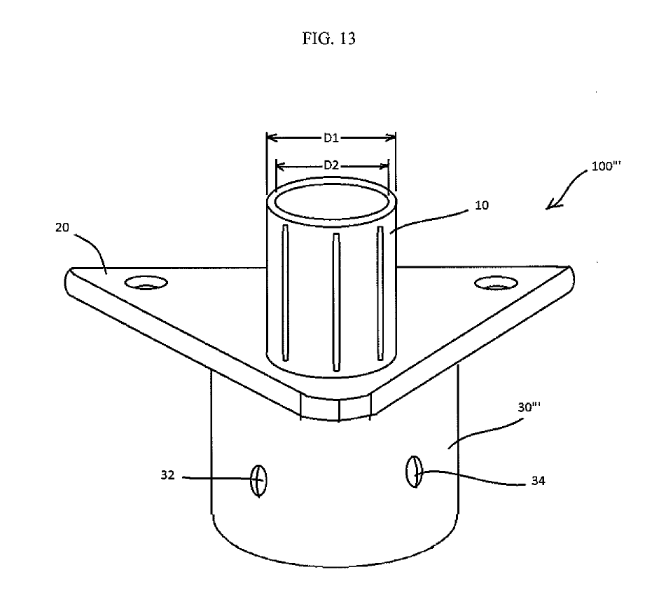

In example embodiments, the shape of the securing member 30 may facilitate connecting the connector 100 to a structure. For example, wooden pallets resemble parallelepiped structures having corners formed at right angles. In example embodiments, the L-shaped securing member 30 may allow the connector 100 to connect to different sides of a wooden pallet (e.g. at a corner). As such, the connector 100 illustrated in the figures is especially suited for attaching to a corner of a wooden pallet. However, if the structure had a different profile, the shape of the securing member 30 may be adjusted to match a contour of the structure. For example, if the structure had a circular shape, when viewed from above, the securing member may be formed to have an arcuate profile with a radius of curvature substantially the same as that of the circular structure (see FIG. 13).

FIG. 4 is a top view of the connector 100. As shown in FIG. 4, the first wing 31 and the second wing 33 may be substantially perpendicular to one another. For the reasons set forth above, this shape is well suited for attaching the connector 100 to a corner of a wooden pallet. Also as shown in at least FIG. 1, the first wing 31 may have a first hole 32 and the second wing 33 may have a second hole 34. In example embodiments, the first hole 32 and the second hole 34 maybe be configured to allow a fastening member, for example, a nail or a screw, to pass therethrough. Thus, in example embodiments, a nail or a screw may be used to connect the connector 100 to a structure, for example, a wooden pallet.

As noted above, each wing 31 and 33 may include a single hole 32 and 34. This, however, is not meant to limit the invention. For example, in example embodiments, each of the first wing 31 and the second wind 33 may include more than one hole. For example, the first wing 31 may include three holes configured to allow a fastener, for example, a nail or a screw, to pass therethrough. This may give a user an option for where a fastener may be applied to connect the connector 100 to a structure. In the alternative, a user may opt to use two or three fasteners with the three holes to connect the connector 100 to the structure thereby allowing for a stronger connection between the connector 100 and the structure. In the alternative, the securing member 30 may be formed without holes altogether and an adhesive may be applied to various surfaces 35 and 36 of the securing member 30 to attach the securing member 30 to the structure.

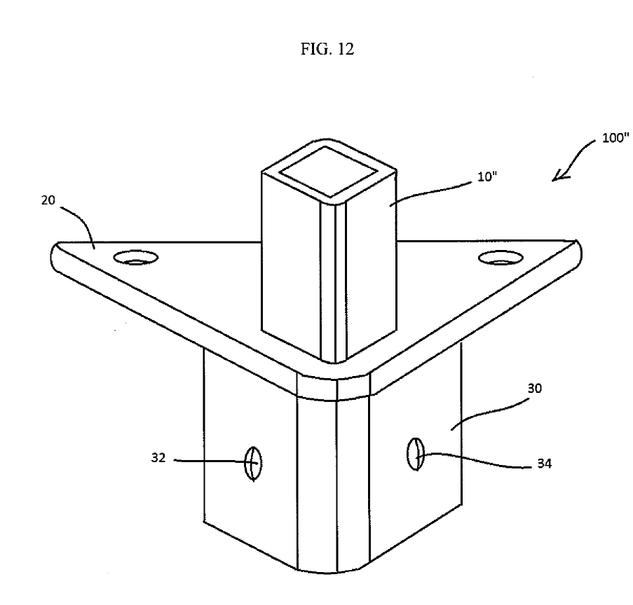

As outlined above, the connector 100 may have a protruding member 10 extending from a second side of the body 20. In example embodiments, the protruding member 10 may be substantially perpendicular to the body 20. As shown in at least FIG. 1, the protruding member 10 may resemble a cylindrical tube. The shape of the protruding member 10, however, is not meant to limit the invention. For example, rather than being formed as a cylindrical tube, the protruding member 10 may actually resemble a square tube (see FIG. 12). On the other hand, rather than being tube shaped members (i.e., substantially hollow members), the body 20 may resemble substantially solid members (i.e., bars). For example, the protruding member 10 may resemble a substantially solid cylinder, or a bar having a polygon shaped cross section. For example, in example embodiments, a cross section of the protruding member may resemble a triangle, a square, a rectangle, a hexagon, or an octagon.

Referring back to FIG. 1, in one specific nonlimiting example embodiment, the protruding member 10 may resemble a cylindrical tube having an annular shaped cross-section. As shown in FIG. 1, the annular shaped cross section may have an outer diameter D1 and an inner diameter D2. In example embodiments, the protruding member 10 may interface with a column 300 in forming a system. On the other hand, the protruding member 10 may function as a base to separate and/or elevate a structure from the ground. Thus, in example embodiments, the protruding member 10 may be used for several purposes.

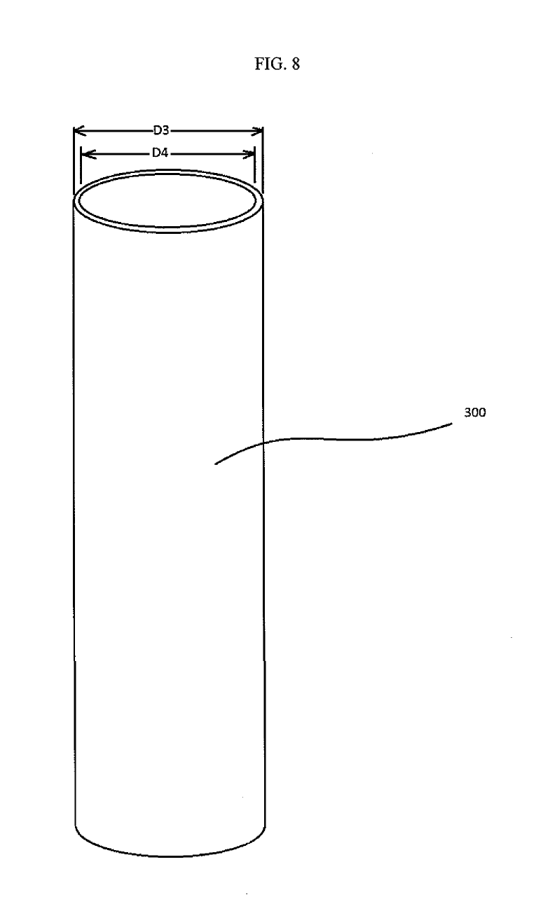

FIG. 6 is a view of a structure 200 in accordance with example embodiments. As shown in FIG. 6, the structure 200 may resemble a parallelepiped having corners formed at right angles. In example embodiments, the structure 200 may be, but is not required to be, a wooden pallet.

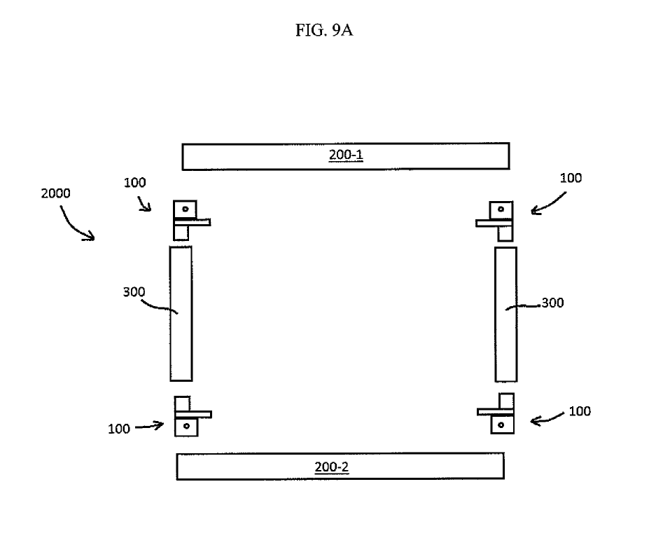

FIGS. 7A and 7B illustrate an example of a first system 1000 in accordance with example embodiments. As shown in FIG. 7A, the first system 1000 may include the structure 200 with four connectors 100 arranged at the corners thereof. In example embodiments, the connectors 100 may be moved to the corners so that a lower surface 210 of the structure 200 rests on the surfaces 25 of the body 20 of the connectors 100. In addition, when arranged at the corners, inside surfaces 35 and 36 of the securing member 30 may bear against or be close to side surfaces of the structure 200. Thus, in example embodiments, when connectors 100 are arranged at the corners of the structure 200 as shown in FIG. 7B, screws or nails maybe used to connect the connector 100 to the structure 200. For example, in example embodiments, screws may pass through the first and/or second holes 32 and 34 of the securing members 30 to attach the securing member 30 to the structure 200. In addition, or as an alternative, fasteners, such as nails or screws, may pass through the holes of the body 20 to secure the connector 100 to an underside of the structure 200. As outlined above, however, an adhesive, for example, glue, may be used to connect the connector 100 to the structure 200. Thus, in example embodiments, rather than using screws or nails to connect the connector 100 to the structure 200, an adhesive may be applied between the structure 200 and surfaces 25, 35 and 36 to bond the connector 100 to the structure 200.

As shown in FIG. 7B, the protruding members 10 of the connectors 100 may act as posts and thus may provide separation between a ground surface and the underside of the structure 200.

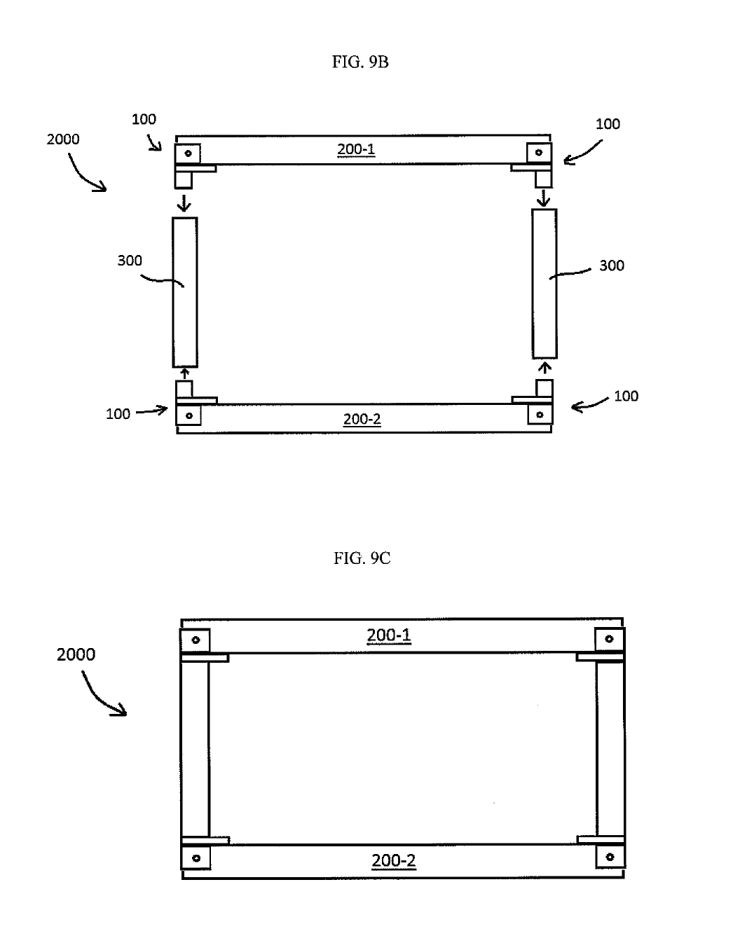

FIG. 8 is a view of a column 300 in accordance with example embodiments. As shown in FIG. 8, the column 300 may resemble a cylindrical tube having an annular cross section. In example embodiments, the annular cross section of the column 300 may have an outer diameter D3 and an inner diameter D4. In example embodiments, the inner diameter D4 may be substantially the same as, or slightly larger than, the outer diameter of the D1 of the protruding member when the protruding member 10 is formed as a cylinder. Thus, in example embodiments, the protruding member 10 may be inserted into the column 300. In the alternative, the protruding member 10 may be formed as a cylindrical tube and the column 300 may be formed as a cylindrical tube (as shown in FIG. 8) or a solid cylindrical member having the outer diameter D3. In this latter example, the inner diameter D2 of the protruding member 10 may be about the same as, or slightly larger than, the outer diameter D3 of the column 300. Thus, in example embodiments, the column 300 may be inserted into the protruding member 10.

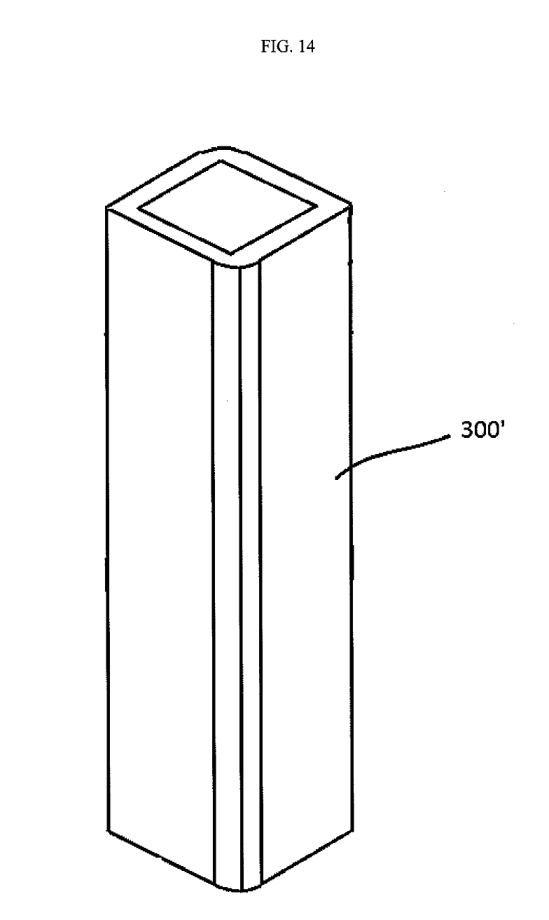

In example embodiments, the column 300 is illustrated as a cylindrical tube, however, the shape of the column 300 is not intended to limit the invention. For example, in example embodiments the column 300, rather than being a cylindrical tube, may be a tube having a polygonal cross-section. For example, the column 300 may have a triangular, square (see FIG. 14), rectangular, hexagonal, or octagonal profile and the protruding member 10 may be similarly formed in accordance with the teachings above. Also, although the figures illustrate the column 300 as being a tubular member, this aspect of example embodiments is not meant to limit the invention. For example, in example embodiments, the column 300 may be a substantially solid member.

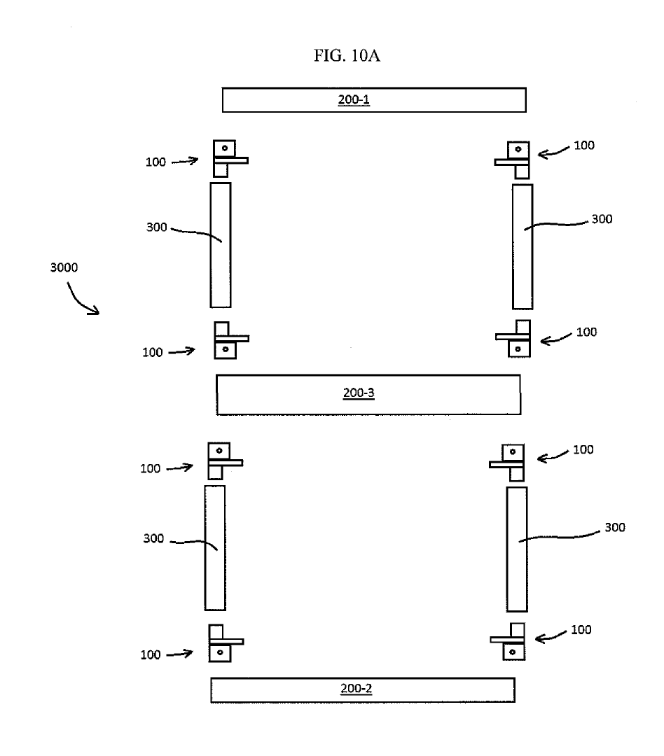

FIG. 9A is an exploded view of another system 2000 in accordance with example embodiments. In example embodiments the system 2000 may include a plurality of connectors 100, a plurality of columns 300, and a plurality of structures 200-1 and 200-2. In example embodiments, the structures 200-1 and 200-2 may be substantially the same as the structure 200 and therefore may be wooden pallets.

In example embodiments it is understood the system 2000 actually includes eight connectors 100 and four columns 300 rather than the four connectors 100 and two columns 300 shown in the figures. Four of the eight connectors 100 are understood to be arranged at four corners of the first structure 200-1 and the other four connectors 100 are arranged at four corners of the second structure 200-2 as shown in at least FIGS. 9A and 9B. In example embodiments, the connectors 100 may be attached to the structures 200-1 and 200-2 by fasteners, for example, screws and/or nails, or by an adhesive, as was previously explained. In example embodiments each of the four columns 300 may connect to two of the connectors 100 as shown in the figures and explained below.

FIG. 9B is a partial exploded view of the system 2000 having the connectors arranged at the corners of their respective structures 200-1 and 200-2. As shown in FIG. 9B, the columns 300 may resemble hollow tubes as shown in FIG. 8. In the nonlimiting example of FIG. 9B, the protruding members 10 of the connectors 100 may be inserted into the hollow spaces of the columns 300 to form the connected system 2000 illustrated in FIG. 9C. Thus, in example embodiments, the connectors 100 and the columns 300 may be used to form a system having two structures separated from one another.

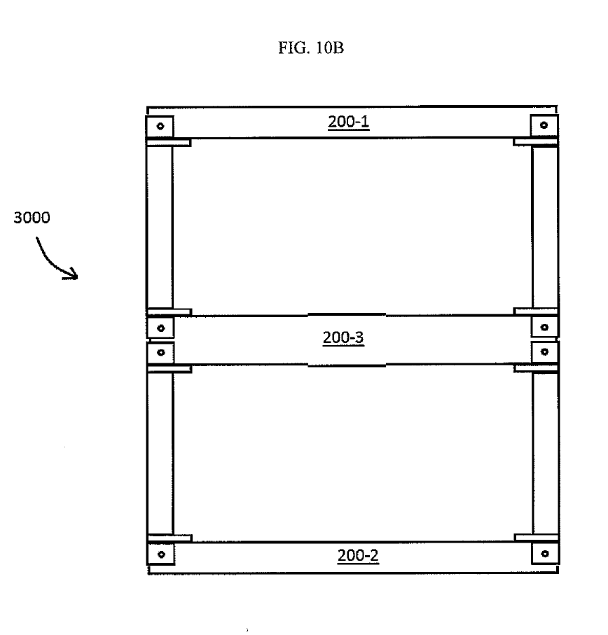

FIG. 10A is an exploded view of another system 3000 in accordance with example embodiments. In example embodiments the system 3000 may include a plurality of connectors 100, a plurality of columns 300, and a plurality of structures 200-1, 200-2, and 200-3. In example embodiments, the structures 200-1, 200-2, and 200-3 may be substantially the same as the structure 200 and thus may be, but are not required to be, wooden pallets.

In example embodiments it is understood the system 3000 actually includes sixteen connectors 100 and eight columns 300 rather than the eight connectors 100 and four columns 300 shown in the figures. Four of the sixteen connectors 100 are understood to be arranged at four lower corners of the first structure 200-1, four of the sixteen connectors 100 are understood to be arranged at four upper corners of the third structure 200-3, four the sixteen connectors 100 are understood to be arranged at four lower corners of the third structure 200-3, and four of the sixteen connectors 100 are arranged at four upper corners of the second structure 200-2. In example embodiments, the connectors 100 may be attached to the structures 200-1, 200-2, and 200-3 via fasteners, for example, nails and/or screws and/or by adhesives, as was previously described. In example embodiments each of the eight columns 300 may connect to two of the connectors 100 of the sixteen connectors as shown in the figures and explained below.

FIG. 10B is a view of the system 3000 having the connectors 100 arranged at the corners of their respective structures 200-1, 200-2, and 200-3. As shown in FIG. 14, the columns 300 may resemble hollow tubes as shown in FIG. 9. In the nonlimiting example of FIG. 10B, the protruding members 10 of the connectors 100 may be inserted into the hollow spaces of the columns 300 to form the connected system 3000 illustrated in FIG. 10B. Thus, in example embodiments, the connectors 100 and the columns 300 may be used to form a system having three structures 200-1, 200-2, and 200-3 separated from one another by the columns 300.

FIGS. 11-13 illustrate other nonlimiting examples of a connector in accordance with example embodiments. For example, FIG. 11 illustrates a connector 100′ which is substantially identical to the connector 100, however, in FIG. 11, the connector 100′ has a rectangular shaped body rather than the triangular shaped body illustrated in FIGS. 1-5. FIG. 12 illustrates another connector 100″ which is substantially identical to the connector 100 except that the protruding member 10″ of the connector 100″ has a rectangular profile rather than a circular profile. FIG. 13 illustrates a connector 100′″ substantially identical to the connector 100 except that the securing member 30″ has a arcuate shape rather than an L shape as shown in FIGS. 1-5.

FIG. 14 illustrates another column 300′ usable with example embodiments. The column 300′ may be substantially identical to the column 300 except that the column 300′ has a square cross section rather than an annular cross section. In example embodiments the column 300′ may be used with a connector having a rectangular cross section such as that shown in FIG. 12. In example embodiments it is understood that the connectors 100′ and 100″ may be used in lieu of the previously described connector 100 and that the column 300′ may be used in lieu of the previously described connector 300 without departing from the teachings of example embodiments.

In example embodiments the previously described connectors 100, 100′, 100″, and 100′″ maybe be made from any suitable material. In one embodiment, the connectors 100, 100′, 100″, and 100′″ are made from plastic and are made from a casting process. Thus, in example embodiments, the connectors 100, 100′, 100″, and 100′″ may be substantially integral in nature. In other embodiments, the body, the protruding member, and the securing member may be separately manufactured and joined together. For example, in this latter embodiment, the body, the protruding member, and the securing member may be made from a metal, for example, steel or aluminum, and each member may be joined together by a conventional method such as, but not limited to, welding. As another example, each of the body, the protruding member, and the securing member may be made from plastic and then joined together using an adhesive.

As previously described, the structures 200, 200-1, 200-2, and 200-3 may be, but are not required to be, a wooden pallet. Thus, in example embodiments, the connectors 100, 100′, and 100″ along with the columns 300 and 300′ may be used to form useful structures, for example, shelves, upon which items may be stored. Thus, example embodiments disclose a useful method of recycling wooden pallets.

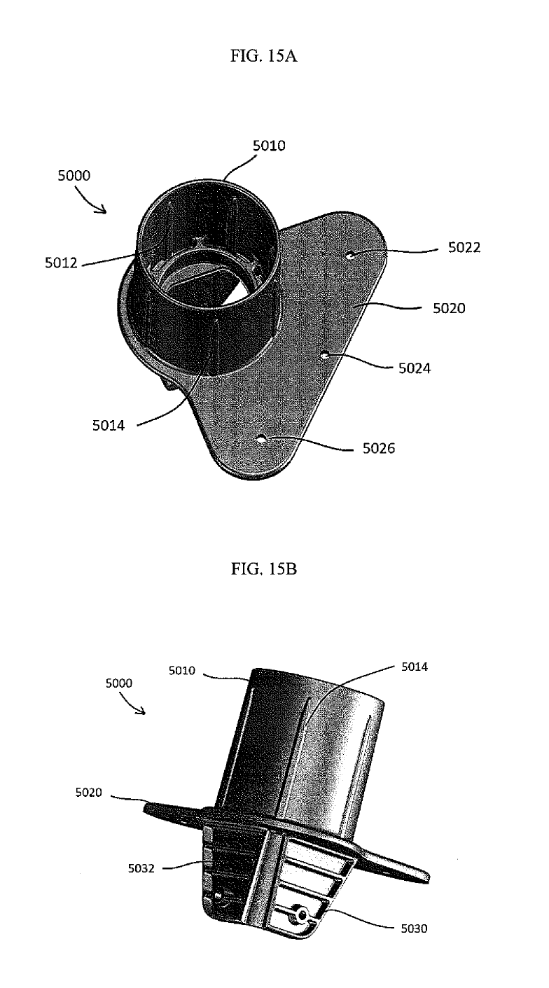

FIGS. 15A and 15B illustrate another connector 5000 in accordance with example embodiments. As shown in FIGS. 15A and 15B, the connector 5000 may include a body 5020, a protruding member 5010 extending from one side of the body 5020, and a securing member 5030 extending from a second side of the body 5020. In example embodiments, the connector 5000 may be somewhat similar to the connector 100. For example, the body 5020 may resemble a triangular flat plate having a plurality of apertures 5022, 5024, and 5026 similar to the body 20 and the plurality of apertures 22, 24, and 26. As yet another point of similarity, the protruding member 5010 may be cylindrical like the protruding member 10, however, in example embodiments, the protruding member 5010 may have inner and outer spacers 5012 and 5014 formed along an inner surface and outer surface of the protruding member 5010. As yet another point of similarity, the securing member 5030 may resemble the securing member 30 except that the securing member 5030 may further include recessed regions 5032 which are not illustrated in the securing member 30. In example embodiments, the connector 5000 may be used in lieu of the connector 100 illustrated in FIGS. 6 and 9A-10B.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

What is claimed is:

1. A connector comprising:
a body;
a securing member extending from a first side of the body; and
a protruding member extending from a second side of the body.

2. The connector of claim 1, wherein the body includes at least one aperture.

3. The connector of claim 1, wherein the body includes a plurality of apertures.

4. The connector of claim 1, wherein the body is substantially plate shaped.

5. The connector of claim 1, wherein the body is substantially triangular shaped.

6. The connector of claim 1, wherein the securing member includes at least one aperture.

7. The connector of claim 1, wherein the securing member is a substantially L-shaped member.

8. The connector of claim 1, wherein the securing member includes a first surface configured to face a first surface of a structure and a second surface configured to face a second surface of the structure.

9. The connector of claim 8, wherein the first surface and the second surface are substantially perpendicular to one another.

10. The connector of claim 9, wherein the first surface includes a first aperture and the second surface includes a second aperture.

11. The connector of claim 1, wherein the protruding member is a bar shaped member.

12. The connector of claim 11, wherein the protruding member is a cylindrical bar.

13. The connector of claim 1, wherein the protruding member is a bar having a polygonal cross-section.

14. The connector of claim 1, wherein the protruding member is a tube shaped member.

15. The connector of claim 1, wherein the tube shaped member has an annular cross section.

16. A system comprising:
a connector of claim 1;
at least one column member; and
at least one structure, wherein the column member is connected to the connector and the connector is connected to the structure.

17. A system comprising:
the connector of claim 1;
a column member configured to attach to the connector, wherein the protruding member is configured to one of insert into an end of the column or enclose an end of the column.

18. The system of claim 17, wherein the end of the column is hollow and the protruding member is configured to insert into the hollow end.

19. The system of claim 17, wherein the protruding member is tube shaped and the end of the column is configured to insert into the protruding member.

20. A kit comprising:
the connector of claim 1; and
a column, wherein
the a body is a substantially plate shaped member having a plurality of holes, the securing member is a substantially L-shaped member having a first wind and a second wing and each of the first and second wings have an aperture, the column is a hollow shaped tube configured to enclose the protruding member.
